(19) United States
(12) Patent Application Publication
(10) Pub. No.: US 2018/0329572 A1
(43) Pub. Date: Nov. 15, 2018

(54) TOUCH DETECTION AND LOCATION IN MULTI-TOUCHSCREEN SYSTEMS

(71) Applicant: Intel Corporation, Santa Clara, CA (US)

(72) Inventors: Meenakshi Gupta, Portland, OR (US); James Edwards, Beaverton, OR (US)

(73) Assignee: Intel Corporation, Santa Clara, CA (US)

(21) Appl. No.: 15/592,917

(22) Filed: May 11, 2017

(51) Int. Cl. G06F 3/041; G06F 3/14

(52) U.S. Cl. CPC G06F 3/0418; G06F 2203/04104; G06F 3/1446

(57) ABSTRACT

The present disclosure is directed to autonomous determination of global touch event coordinates on a system that includes at least two touchscreen devices configured to display a scene in a collage display mode. In the collage display mode the image in a first touchscreen device is apportioned between and displayed on a plurality of touchscreen devices. The collage display mode beneficially provides enhanced resolution, greater fluidity, and less disruption or discontinuities as objects and/or moving objects included in the scene transition between touchscreen devices while enabling full touchscreen functionality across the plurality of touchscreen devices including the image displayed in collage mode.

### TECHNICAL FIELD

The present disclosure relates to touch detection and location technologies for touchscreen systems.

### BACKGROUND

Systems continue to increase in both display output and processing power. Formerly the exclusive domain of rather large desktop systems with dedicated graphics cards supporting multi-monitor output and typically used for computationally intensive graphical design, computer-aided design (CAD) and computer aided manufacturing (CAM), even modern portable devices often provide multi-display capabilities and provide considerable computational horsepower. For example, clamshell type portable devices may feature dual monitor setups that provide various operating modes dependent on the orientation and/or configuration of the display devices: a conventional clamshell mode (one display active/one display dark); a clamshell dual mode in which the display is duplicated on each display device; and a tablet mode in which the second display can be either dark or duplicative of the first display.

Touchscreen displays are increasing in usefulness and finding widespread support within modern desktop and portable operating systems such as Windows, OSx, iOS, Android, and Linux, among others. Touchscreen technology may include any form of interface that enables a user to interact with a display image via a finger, multiple fingers, a gesture, or a stylus. Inputs obtained via a touchscreen input may include coordinates (e.g., an x, y pair) that locate the touch event on the surface of the touchscreen. Such touch input data is typically received by the operating system and then passed (e.g., via an Application Programming Interface or “API”) to the application generating the display image.

For some users, particularly portable computer users, a multiple display configuration may be beneficial if the displays are logically arranged to function as a single larger display device—such an operating mode may be referred to as a “collage” mode of operation where the image appearing in the first display is stretched across a number (e.g., two) displays, with each of the displays providing a portion of a user's active workspace. Issues arise, however, when the displays are touchscreen devices since most devices identify the location of a touch event using a coordinate system that is local to each display. Thus, if a single display system having an “A” in the upper left corner of the display, a “B” in the upper center of the display, and a “C” in the upper right corner of the display is operated in a dual monitor collage mode, the “A” will appear in the upper left corner of the first display, the “B” will be split between the first and second displays, appearing in part in the upper right corner of the first display and in part in the upper left corner of the second display, and the “C” will appear in the upper right corner of the second display. The lack of alignment between the touch matrix on the touchscreen device and the display image makes selection of an object appearing at location “B” and may cause the unintended performance of an undesirable or problematic action.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A depicts an illustrative system that includes: video processing circuitry, a number of touchscreen devices, processor circuitry including collage mode touch processing circuitry, and one or more storage devices, in accordance with at least one embodiment described herein;

FIG. 1B depicts two illustrative, adjacent, touchscreen devices operated in a collage display mode, where each of the touchscreen devices includes a respective individual touch detection coordinate system and where the collage mode touch processing circuitry generates a global touch detection coordinate system that spans, covers, and/or extends across all or a portion of the touchscreen devices used to provide the collage display mode, in accordance with at least one embodiment described herein;

FIG. 2 is an input/output (I/O) diagram of an illustrative collage mode touch processing circuitry, in accordance with at least one embodiment described herein;

FIG. 3 is a block diagram of an illustrative processor-based device capable of implementing collage mode touch processing circuitry to determine global coordinates (X_{GLOBAL}, Y_{GLOBAL}) of a touch event in a system that includes at least two touchscreen devices operating in a collage display mode, in accordance with at least one embodiment described herein;

FIG. 4A is an elevation view of an illustrative system in which two touchscreen devices that are not operated in collage display mode, in accordance with at least one embodiment described herein;

FIG. 4B is an elevation view of the illustrative system in which the two touchscreen devices are operated in a collage display mode to enable the collage mode touch processing circuitry to determine the global coordinates (X_{GLOBAL}, Y_{GLOBAL}) of a touch event, in accordance with at least one embodiment described herein;

FIG. 5 is a system diagram depicting an illustrative system that includes interfaces for providing a collage display mode input selector and collage mode touch processing circuitry to intercept and convert local touch coordinates (X_{LOCAL}, Y_{LOCAL}) and touchscreen device information to global touch coordinates (X_{GLOBAL}, Y_{GLOBAL}) prior to forwarding the global location coordinates (X_{GLOBAL}, Y_{GLOBAL}) from kernel ring 0 to user ring 3, in accordance with at least one embodiment described herein;

FIG. 6 is a high-level logic flow diagram of an illustrative method of translating or otherwise converting local coordinates (X_{LOCAL}, Y_{LOCAL}) associated with a touch event on one of at least two touchscreen devices used to provide an image of a scene in a collage display mode, in accordance with at least one embodiment described herein;

FIG. 7 is a high-level logic flow diagram of an illustrative method of apportioning a single scene into a number of image portions for display on at least two touchscreen devices in a collage display mode, in accordance with at least one embodiment described herein; and

FIG. 8 is a high-level flow diagram of an illustrative method of determining global coordinates (X_{GLOBAL}, Y_{GLOBAL}) using local coordinates (X_{LOCAL}, Y_{LOCAL}) of a touch event that has occurred on one of the at least two touchscreen devices, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The systems, methods, and apparatuses disclosed herein enable the detection and location of a touch event, multitouch event, gesture event, or stylus event on a touchscreen input device that is communicably coupled to a number of other touchscreen devices to provide a touchscreen display system capable of operating in a “collage” mode in which the desktop image is apportioned across all or a portion of a plurality of touchscreen devices. Collage mode differs from Windows extended mode in an important aspect—in collage mode the image appearing in a first touchscreen device is stretched across a plurality of touchscreen devices, effectively increasing the size of the touchscreen display (e.g., two 27″ monitors having a display area of 8.5 inches by 25.2 inches would effectively provide a 51″ monitor having a display area of 8.5 inches by 50.4 inches); Windows® extended mode only increases the desktop real estate without “stretching” or otherwise altering the image in the first touchscreen display. More importantly, Windows® extended mode does NOT support the use of touchscreen functionality. The systems and methods described herein fully support the use of touchscreen functionality when the image in the first touchscreen display is presented in collage mode across a plurality of touchscreen devices.

Collage mode uses a technique called “bezel correction” that permits the user to view a continuous image across some or all communicably coupled, adjacent, display devices. Collage mode allows a user to combine multiple monitors to create a single, unified, desktop user interface having a larger viewing area and increased resolution. While in collage mode, the user is beneficially able to enjoy higher quality pictures and videos using multiple low-resolution supported display devices. In many instances, multiple smaller display devices may be more cost effective than a single, larger, display device.

Thus, in a touchscreen display system operated in collage mode, the graphical output of the system is apportioned or otherwise allocated across a plurality of display devices. Thus, for example, in a four-display system arranged in a 2×2 matrix, operating in collage mode would place the upper left quadrant of the display output in the upper left display device; the upper right quadrant of the display output in the upper right display device; the lower left quadrant of the display output in the lower left display device; and, the lower right quadrant of the display output in the lower right display device. Such a system advantageously simulates a much larger (and much higher cost) single display device with appropriately positioned, multiple, smaller display devices. Such a system may beneficially be implemented using a portable device in which two display devices are positioned along a common horizontal or vertical centerline axis.

The systems and methods disclosed herein support automatic switching of the display mode multi-display portable device based on prior user actions and prior user configuration. For example, when used in a tablet mode, Windows may automatically set the display mode for the secondary screen to a normal desktop PC, the only useful option for tablet mode. In a clamshell book system mode (e.g., a mode in which the laptop display devices are positioned along a common horizontal axis), the dual display devices may be set to an extended mode (e.g., the desktop is duplicated on each of the display devices) or collage mode (e.g., the desktop is apportioned between the first display device and the second display device). Once set, the system may automatically enter either extended or collage mode when the portable device is positioned in book system mode. Importantly, while operating systems such as Windows may accurately support touchscreen operation when in clone or extended mode, Windows is unable to support touchscreen operations when display devices are operated in collage mode due to the bezel correction applied during collage mode. The systems and methods described herein beneficially permit and fully support the use of touchscreen devices when such devices are operated in collage mode (i.e., operated in a mode in which bezel correction is applied).

A system to provide scaled touchscreen inputs across a plurality of display devices when in a collage mode is provided. The system may include processor circuitry to couple to a plurality of touchscreen devices, at least two of the plurality of touchscreen devices to receive respective portions of an image, the at least two touchscreen devices to present the respective portions of the image in a collage mode; a storage device that includes instructions that, when executed by the processor circuitry, cause at least a portion of the processor circuitry to provide collage mode touch processing circuitry, the collage mode touch processing circuitry to, responsive to receipt of an input indicative of a collage mode display: determine a touch input resolution (X_{TOUCH}, Y_{TOUCH}) for each touchscreen device included in the plurality of touchscreen devices; and translate local touch coordinates (X_{LOCAL}, Y_{LOCAL}) of a touch event on one of the at least two touchscreen displays to global touch coordinates (X_{GLOBAL}, Y_{GLOBAL}) in a global coordinate system covering at least a portion of the at least two touchscreen devices.

A method to identify the location of a touch event on one of a plurality of touchscreen devices is provided. The method may include determining, via collage mode touch processing circuitry, a respective touch input resolution (X_{TOUCH}, Y_{TOUCH}) for each of a plurality of communicably coupled touchscreen devices, at least two of the touchscreen devices to receive respective portions of an image, the at least two touchscreen devices to present respective portions of an image in a collage mode; and translating local touch coordinates (X_{LOCAL}, Y_{LOCAL}) of a touch event on one of the at least two touchscreen devices to global touch coordinates (X_{GLOBAL}, Y_{GLOBAL}) in a global coordinate system covering at least a portion of the at least two touchscreen devices.

A collage mode touch controller is provided. The controller may include a collage mode touch processing circuitry to: determine a touch input resolution (X_{TOUCH}, Y_{TOUCH}) for each of a plurality of communicably coupled touchscreen devices; and translate local coordinates (X_{LOCAL}, Y_{LOCAL}) of a touch event on one of at least two of the plurality of touchscreen devices to global coordinates (X_{GLOBAL}, Y_{GLOBAL}) in a global coordinate system that covers the at least two touchscreen devices, the at least two touchscreen devices to present respective portions of an image in a collage mode.

A non-transitory computer readable medium that includes instructions is provided. The instructions, when executed, may cause collage mode touch processing circuitry to: determine a respective touch input resolution (X_{TOUCH}, Y_{TOUCH}) for each of a plurality of communicably coupled touchscreen devices, at least two of the touchscreen devices to receive respective portions of an image, the at least two touchscreen devices to present respective portions of an image in a collage mode; and translate local touch coordinates (X_{LOCAL}, Y_{LOCAL}) of a touch event on one of the at least two touchscreen devices to global touch coordinates (X_{GLOBAL}, Y_{GLOBAL}) in a global coordinate system that covers at least a portion of the at least two touchscreen devices.

A system to identify the location of a touch event on one of a plurality of touchscreen devices is provided. The system may include a means for determining a respective touch input resolution (X_{TOUCH}, Y_{TOUCH}) for each of a plurality of communicably coupled touchscreen devices, at least two of the touchscreen devices to receive respective portions of an image, the at least two touchscreen devices to present respective portions of an image in a collage mode; and a means for translating local touch coordinates (X_{LOCAL}, Y_{LOCAL}) of a touch event on one of the at least two touchscreen devices to global touch coordinates (X_{GLOBAL}, Y_{GLOBAL}) in a global coordinate covering at least a portion of the at least two touchscreen devices.

As used herein the terms “top,” “bottom,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, the term “logically associated” when used in reference to a number of objects, systems, or elements, is intended to convey the existence of a relationship between the objects, systems, or elements such that access to one object, system, or element exposes the remaining objects, systems, or elements having a “logical association” with or to the accessed object, system, or element. An example “logical association” exists between relational databases where access to an element in a first database may provide information and/or data from one or more elements in a number of additional databases, each having an identified relationship to the accessed element. In another example, if “A” is logically associated with “B,” accessing “A” will expose or otherwise draw information and/or data from “B,” and vice-versa.

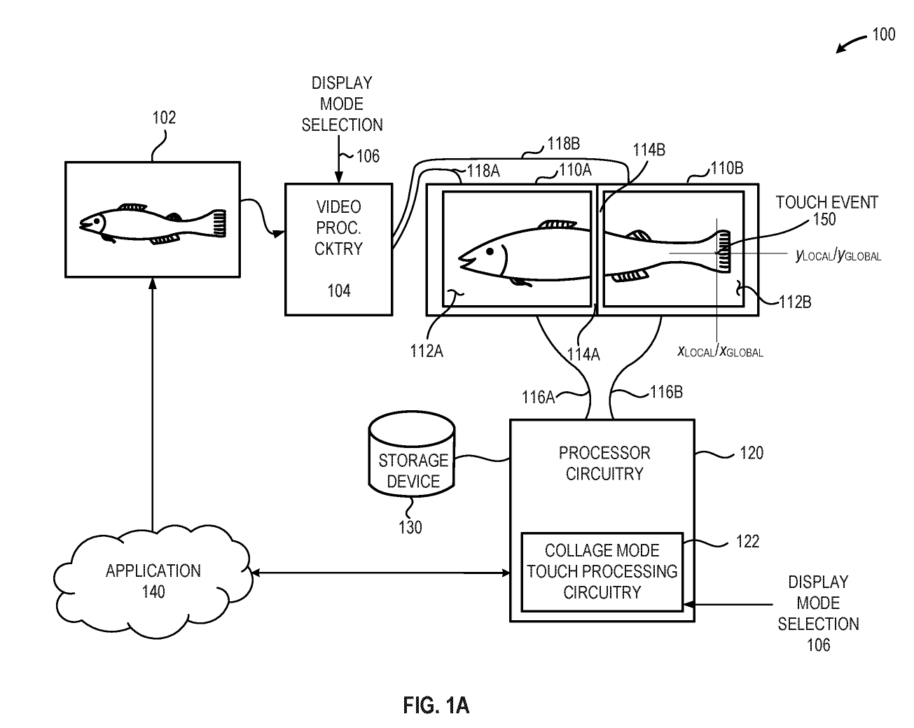

FIG. 1A depicts an illustrative system 100 that includes: video processing circuitry 104, a number of touchscreen devices 110A-110n (collectively “touchscreen devices 110”), processor circuitry 120 including collage mode touch processing circuitry 122, and one or more storage devices 130, in accordance with at least one embodiment described herein. FIG. 1B depicts two illustrative, adjacent, touchscreen devices 110A, 110B operated in a collage display mode, where each of the touchscreen devices 110A and 110B includes a respective individual touch detection coordinate system 160A and 160B; and where the collage mode touch processing circuitry 122 generates a global touch detection coordinate system 170 that spans, covers, and/or extends across all or a portion of the touchscreen devices 110 used to provide the collage display mode, in accordance with at least one embodiment described herein. As depicted in FIG. 1A, the system 100 may be placed in a collage mode in which the output of the video processor 104 is apportioned between a first touchscreen device 110A and a second touchscreen device 110B. A bezel 114A at least partially surrounds a first touchscreen display 112A in the first touchscreen device 110A. Similarly, a bezel 114B at least partially surrounds the second touchscreen display 112B in the second touchscreen device 110B.

In some implementations, the video processing circuitry 104 may selectively divide or otherwise apportion the scene 102 into two portions, the first portion of scene 112A presented on the first touchscreen device 110A and the second portion of scene 112B presented on the second touchscreen device 110B. Although two touchscreen devices 110A, 110B are displayed in FIG. 1 and discussed herein for clarity, one or skill in the relevant arts may readily appreciate the application of the principles described herein to any number of touchscreen devices, such as a 2×2 matrix of 4 touchscreen devices.

Referring now to FIG. 1B, the collage mode touch processing circuitry 122 provides or otherwise extends touchscreen functionality across multiple touchscreen devices 110 displaying the scene 102 in a collage display mode. Each of the touchscreen devices 110A, 110B detects the location of a touch event, multitouch event, or gesture event 150 (hereinafter, collectively “touch event 150”) using a coordinate system 160A and 160B local to the respective touchscreen device 110A and 110B. Thus, the touch event 150 on touchscreen device 110B occurs at local coordinates (X_{LOCAL}, Y_{LOCAL}).

The collage mode touch processing circuitry 122 resolves the ambiguity and identifies the global x-y coordinates (X_{GLOBAL}, Y_{GLOBAL}) of the touch event 150 using a global coordinate system 170 that covers, spans, or extends across all or a portion of the at least two touchscreen devices used to display the scene 102 in a collage display mode. Using global coordinate system 170, the collage mode touch processing circuitry 122 uniquely identifies the global x-y coordinates (X_{GLOBAL}, Y_{GLOBAL}) of the touch event 150. By uniquely identifying the global x-y coordinates (X_{GLOBAL}, Y_{GLOBAL}), the collage mode touch processing circuitry 122 beneficially provides touchscreen functionality even when the touchscreen devices 110A, 110B are placed in collage display mode since each point in the global touch coordinate system may be mapped to a unique point on the displayed scene 102. In embodiments, the collage mode touch processing circuitry 122 may provide 124 (e.g., via an Application Programming Interface or “API”) the global coordinates (X_{GLOBAL}, Y_{GLOBAL}) of the touch event 150 as a user input to the application 140 executed by the system 100.

Each of the touchscreen devices 110 used to provide the scene 102 in collage display mode is assigned a unique identifier. In some implementations, the unique identifier assigned to the touchscreen devices 110 may be generated by the operating system of the system 100. In other implementations, the unique identifier assigned to the touchscreen devices 110 may be generated by the video processing circuitry 104. In yet other implementations, the unique identifier assigned to the touchscreen devices 110 may be generated by the collage mode touch processing circuitry 122. For example, in some implementations, the collage mode touch processing circuitry 122 may assign an identifier such as TOUCHSCREENID=1 to the first touchscreen device 110A and an identifier such as TOUCHSCREENID=2 to the second touchscreen device 110B.

Each of the touchscreen devices 110 used to provide the scene 102 in collage display mode may have the same or different touch resolution, screen resolution, or both touch resolution and screen resolution. In embodiments, the first touchscreen device 110A and the second touchscreen device 110B may include a display device having the same display resolution and a touchscreen interface having the same resolution. In such embodiments, the collage mode touch processing circuitry 122 may then determine the global x-y coordinates (X_{GLOBAL}, Y_{GLOBAL}) of the touch event 150 on the collage mode touchscreen devices 110A and 110B that are aligned along a common horizontal axis using the following equation:

X_{GLOBAL}=X_{LOCAL}+((TOUCHSCREENID−1)*X_{TOUCH})) (1)

Y_{GLOBAL}=Y_{LOCAL} (2)

Where: X_{LOCAL}=local x coordinate of touch event 150
Y_{LOCAL}=local y coordinate of touch event 150
X_{GLOBAL}=global x coordinate of touch event 150
Y_{GLOBAL}=global y coordinate of touch event 150
X_{TOUCH}=touchscreen device touch resolution in X direction

In such embodiments, the collage mode touch processing circuitry 122 may then determine the global x-y coordinates (X_{GLOBAL}, Y_{GLOBAL}) of the touch event 150 on the collage mode touchscreen devices 110A and 110B that are aligned along a common vertical axis via the following equation:

X_{GLOBAL}=X_{LOCAL} (3)

Y_{GLOBAL}=Y_{LOCAL}+((TOUCHSCREENID−1)*Y_{TOUCH})) (4)

Where: X_{LOCAL}=local x coordinate of touch event 150
Y_{LOCAL}=local y coordinate of touch event 150
X_{GLOBAL}=global x coordinate of touch event 150
Y_{GLOBAL}=global y coordinate of touch event 150
Y_{TOUCH}=touchscreen device touch resolution in Y direction

The video processing circuitry 104 may include any number and/or combination of devices and/or systems capable of receiving an image 102 from an application 140 executed by the system 100 and apportioning the scene 102 to provide a collage display mode scene to at least two touchscreen devices 110A, 110B included in a plurality of touchscreen devices 110. In implementations, the video processing circuitry 104 may include a display mode selection input 106 that cause the video processing circuitry 104 to selectively provide content for display on each of the at least two touchscreen devices 110A, 110B. The display mode selection input 106 may be set manually by the system user or automatically by the operating system and/or one or more applications 140. For example, the display mode selection input 140 may be automatically set by the operating system, and/or an application 140 based on the position, configuration, and/or orientation of one or more touchscreen devices 110 communicably coupled to the system 100. For example, the display mode selection input 106 may automatically cause the video processing circuitry 104 to generate output using only a single touchscreen device 110 when in a clamshell single display mode or in a tablet display mode. In another example, the display mode selection input 106 may automatically cause the video processing circuitry 104 to generate output using two touchscreen devices 110A, 110B when in a clamshell dual mode. In another example, the display mode selection input 106 may automatically cause the video processing circuitry 104 to generate output using two touchscreen devices 110A, 110B when in a collage display mode.

In implementations, the video processing circuitry 104 may be disposed, in whole or in part, within the processor circuitry 120. In other implementations, the video processing circuitry 104 may be disposed, in a device external to the processor circuitry 120, for example in a stand along graphical processing unit, graphical processing circuitry, or graphics card. In some implementations, the video processing circuitry 104 may support the communicable coupling of a plurality of touchscreen devices 110, such as the at least two touchscreen devices 110A and 110B depicted in FIG. 1A. In some implementations, the video processing circuitry 104 may be disposed external to or remote from the system 100. For example, a client/server based system in which the touchscreen devices 110A, 110B communicably couple to a client or thin client device while the video processing circuitry 104 is disposed in a remotely connected server. In another example, the video processing circuitry may be disposed in one or more cloud or Internet based devices while the touchscreen devices 110A, 110B are communicably coupled to a remote device having at least two touchscreen devices 110, such as a portable computer, handheld computer, wearable computer, or smartphone.

The plurality of touchscreen devices 110 may include any number and/or combination of touchscreen devices 110A-110n. In at least some embodiments, at least two of the plurality of touchscreen devices 110 may be used to provide a collage mode display as depicted in FIGS. 1A and 1B. In embodiments, each of the plurality of touchscreen devices 110 may employ any touch technology (e.g., inductive, capacitive, optical) In embodiments, each of the plurality of touchscreen devices 110 may have the same viewable area (measured diagonally—11 inches (in.), 13.6 in., 15 in., 17 in., 20 in., 24 in., 27 in., 32 in., etc.). In embodiments, each of the plurality of touchscreen devices 110 may have the same or a different display resolution (1024×768, 1360×768, 1280×1024, 1920×1080, 2048×1080, 2560×1440, 3840×2400, 4096×3072, 5120×2880, 7680×4320, etc.). In embodiments, each of the plurality of touchscreen devices 110 may have the same or a different touch resolution. In at least some embodiments, the at least two touchscreen devices 110A, 110B may have the same viewable area, screen resolution, and touch resolution.

Each of the plurality of touchscreen devices 110 may communicably couple 118A, 118B to the video processing circuitry 104 using any wired or wireless technology to receive the scene 102. For example, the touchscreen devices 110 may be communicably coupled to the video processing circuitry 104 using one or more of the following: video graphics array (VGA), high definition multimedia interface (HDMI), digital visual interface (DVI), DisplayPort, IEEE 1394 (Latest Version—FIREWIRE®), Thunderbolt® (Intel, Inc, SANTA CLARA, Calif.). Each of the plurality of touchscreen devices 110 may communicably couple 116A, 116B to the collage mode touch processing circuitry 122 using any wired or wireless technology to receive the scene 102. For example, the touchscreen devices 110 may be communicably coupled to the collage mode touch processing circuitry 122 using one or more of the following: BLUETOOTH®, near field communication (“NFC”), universal serial bus (“USB”), or similar.

A bezel 114 or similar frame or structure at least partially surrounds each of the plurality of touchscreen devices 110. The bezel 114 may have a constant or variable width and may or may not have the same width about the entire perimeter of the display area 112. For example, the bezel 114 may have a width of about 1.25 cm along the sides and top of the display area 112 and a width that varies from 1.5 to 2.0 cm along the bottom of the display area 112. When placed adjacent to another touchscreen device 110, the combined bezel width may be about 2.5 cm. The collage mode touch processing circuitry 122 provides for the determination of a global coordinates (X_{GLOBAL}, Y_{GLOBAL}) associated with a touch event 150 on either of the at least two touchscreen devices 110A, 110B, thereby beneficially permitting the use of the touchscreen functionality while the touchscreen devices 110A, 110B display a scene 102 in a collage display mode.

Since touchscreen device bezel dimensions vary between manufacturers, in embodiments, the collage mode touch processing circuitry 122 may, upon initial connection, coupling, or configuration of each touchscreen device 110 (and/or occasionally, periodically, or aperiodically thereafter) display one or more test patterns on the at least two touchscreen devices 110A, 110B used to provide the collage display mode. The system user may then adjust one or more collage mode touch processing circuitry 122 parameters to cause the test pattern to display properly (e.g., as a perfect circle) across the at least two touchscreen devices 110A, 110B.

The processor circuitry 120 may include any number and/or combination of electrical components, semiconductor devices, and/or logic elements capable of executing machine-readable instruction sets stored or otherwise retained, at least in part, on the storage device 130. In embodiments, at least a portion of the processor circuitry 120 may be transformed through the execution of one or more machine readable instruction sets to dedicated and particular collage mode touch processing circuitry 122. The processor circuitry 120 may include one or more single- or multi-core controllers, processors, microprocessors, systems on a chip (SoC), application specific integrated circuits (ASIC), programmable gate array (PGA), reduced instruction set computers (RISC), or combinations thereof.

The collage mode touch processing circuitry 122 may receive one or more signals containing, conveying or otherwise carrying information and/or data indicative of the local coordinates (X_{LOCAL}, Y_{LOCAL}) of a touch event 150 and information and/or data indicative of a unique identifier associated with a respective touchscreen device 110A or 110B receiving the touch event 150. In embodiments, such information and/or data may be first received by the system operating system (0/S) and forwarded by the O/S to the collage mode touch processing circuitry 122. In response to receipt of the unique ID and local coordinates (X_{LOCAL}, Y_{LOCAL}) of the touch event 150, the collage mode touch processing circuitry 122 converts the local coordinates (X_{LOCAL}, Y_{LOCAL}) to global coordinates (X_{GLOBAL}, Y_{GLOBAL}). The collage mode touch processing circuitry 122 forwards the information indicative of the global coordinates (X_{GLOBAL}, Y_{GLOBAL}) of the touch event 150 to the application 140. In embodiments, the collage mode touch processing circuitry 122 may forward information and/or data indicative of the type of touch event 150 (single touch, multi-touch, gesture, etc.) to the application 140. In some implementations, the processor circuitry 120 may forward the information and/or data indicative of the type of touch event 150 (single touch, multi-touch, gesture, etc.) to the application 140. In some implementations, the system O/S may forward the information and/or data indicative of the type of touch event 150 (single touch, multi-touch, gesture, etc.) to the application 140.

The storage device 130 may include any number and/or combination of non-transitory storage device or media. Example storage devices may include, but are not limited to, one or more: solid state storage devices (SSDs); hard disk drives (HDDs), atomic storage devices, molecular storage devices, organic storage devices, electro-resistive storage devices, optical storage devices, or combinations thereof. In some implementations, the storage device 130 may be disposed internal or local to the system 100. In some implementations, the storage device 130 may be disposed external to or remote from the system 100 and may be tethered or wirelessly connected to the system 100, for example via one or more networks.

The application 140 may include any application capable of generating a scene 102 for display on the at least two touchscreen devices 110A, 110B in a collage display mode. In some implementations, one or more application programming interfaces (API) may uni-directionally or bi-directionally pass information and/or data from the collage mode touch processing circuitry 122 to the application 140. In some implementations, one or more application programming interfaces (API) may uni-directionally or bi-directionally pass information and/or data from the operating system to the application 140.

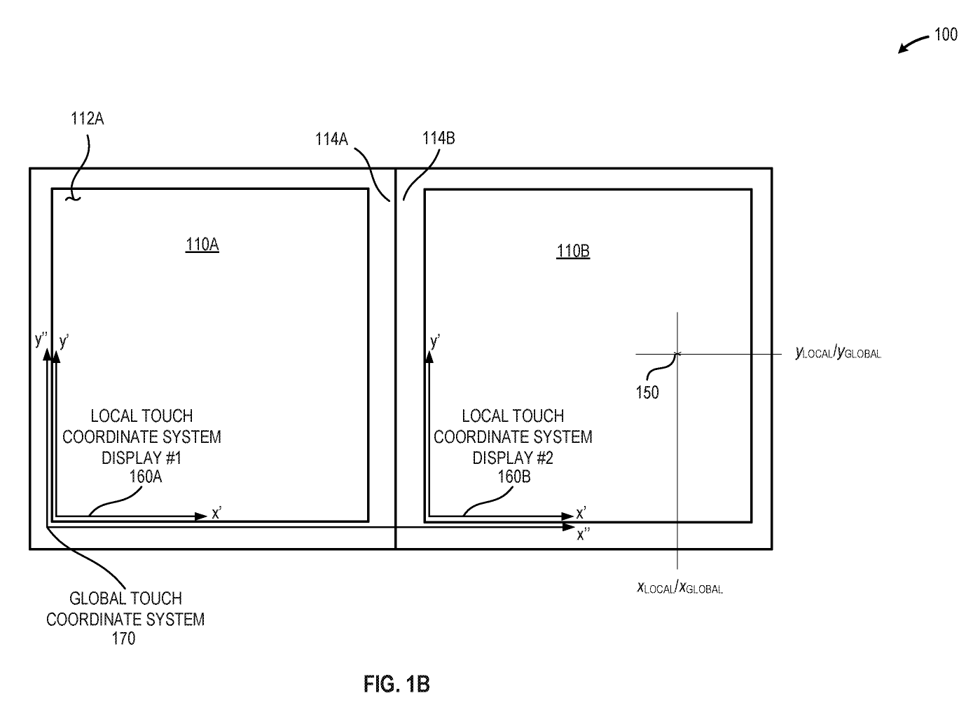

FIG. 2 is an input/output (I/O) diagram of an illustrative collage mode touch processing circuitry 122, in accordance with at least one embodiment described herein. A first input 210 to the collage mode touch processing circuitry 122 includes one or more signals 116A, 116B that includes information and/or data indicative of the TOUCHSCREENID associated with the touchscreen device 110 receiving the touch event 150. In some implementations, the input 210 may provide the information and/or data indicative of the TOUCHSCREENID associated with the touchscreen device 110 receiving the touch event 150 regardless of the system display mode. In other implementations, the input 210 may provide the information and/or data indicative of the TOUCHSCREENID associated with the touchscreen device 110 receiving the touch event 150 only when the system 100 is in the collage display mode.

A second input 220 to the collage mode touch processing circuitry 122 further includes one or more signals 116A, 116B that include information and/or data indicative of the local coordinates (X_{LOCAL}, Y_{LOCAL}) of the touch event 150. In some implementations, the input 220 may provide the information and/or data indicative of the local coordinates of a touch event 150 regardless of the system display mode. In other implementations, the input 210 may provide the information and/or data indicative of the local coordinates of the touch event 150 only when the system 100 is in the collage display mode.

A third input 230 to the collage mode touch processing circuitry 122 further includes one or more signals 106 that include information and/or data indicative of the system 100 being placed in a collage display mode where at least two touchscreen devices 110A, 110B display a received scene 102 in a collage display mode. In some implementations, the input 230 may be autonomously generated by the system O/S based, at least in part, on the configuration, position, and/or orientation of the at least two touchscreen devices 110A, 110B. For example, the input 230 may include information and/or data indicative of a collage display mode when touchscreen devices 110A and 110B are positioned in a clamshell book mode.

An output 240 from the collage mode touch processing circuitry 122 includes a signal 124 that includes information and/or data indicative of the global coordinates (X_{GLOBAL}, Y_{GLOBAL}) of the touch event 150. In some implementations, the collage mode touch processing circuitry 122 may provide the information and/or data indicative of the global coordinates (X_{GLOBAL}, Y_{GLOBAL}) to the application 140, for example via an API. In other implementations, the collage mode touch processing circuitry 122 may provide the information and/or data indicative of the global coordinate (X_{GLOBAL}, Y_{GLOBAL}) to the system O/S and the system O/S may provide the information and/or data indicative of the global coordinates (X_{GLOBAL}, Y_{GLOBAL}) to the application 140, for example via an API.

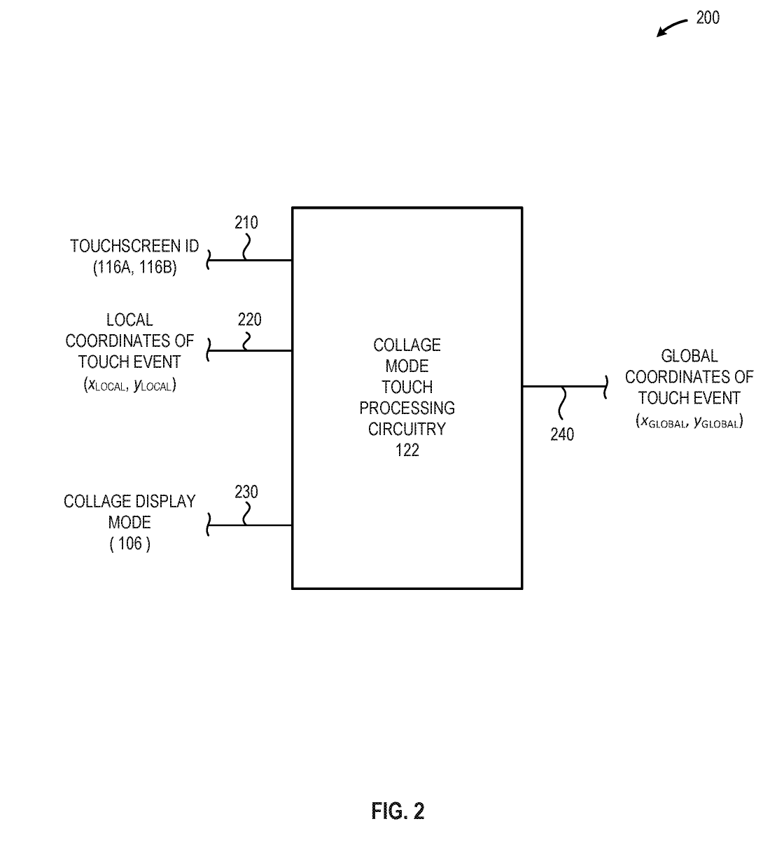

FIG. 3 and the following discussion provide a brief, general description of the components forming an illustrative processor-based device 302 capable of implementing collage mode touch processing circuitry 122 to determine global coordinates (X_{GLOBAL}, Y_{GLOBAL}) of a touch event 150 using a system 110 that includes at least two touchscreen devices 110A, 110B operating in a collage display mode, in accordance with at least one embodiment described herein. The processor-based device 302 includes processor circuitry 120 capable of implementing, forming, or otherwise collage mode touch processing circuitry 122 in which the various illustrated embodiments described herein may be implemented. Although not required, some portion of the embodiments will be described in the general context of machine-readable or computer-executable instruction sets, such as program application modules, objects, or macros being executed by video processing circuitry 104, processor circuitry 120, and/or collage mode touch processing circuitry 122. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The processor circuitry 120 and/or the collage mode touch processing circuitry 122 may include any number of circuits, some or all of which may include programmable and/or configurable combinations of electronic components, semiconductor devices, and/or logic elements that are disposed partially or wholly in a PC, server, or other computing system capable of executing machine-readable instructions. The processor-based device 302 may include processor circuitry 120, and may, at times, include a bus or similar communications link 316 that communicably couples and facilitates the exchange of information and/or data between various system components including: the video processing circuitry 104, the processor circuitry 120, the collage mode touch processing circuitry 122, the storage device 130, and a system memory 314. The processor-based device 302 may be referred to in the singular herein, but this is not intended to limit the embodiments to a single device and/or system, since in certain embodiments, there will be more than one processor-based device 302 that incorporates, includes, or contains any number of communicably coupled, collocated, or remote networked circuits or devices.

The processor circuitry 120 may include any number, type, or combination of devices. At times, the processor circuitry 120 may be implemented in whole or in part in the form of semiconductor devices such as diodes, transistors, inductors, capacitors, and resistors. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), field programmable gate arrays (FPGAs), and the like. Example processor circuitry may include, but is not limited to, single- and multi-core processors and microprocessors such as: Intel® Pentium® series processors; Intel® Xeon® series coprocessors; Intel® Core® series processors; Intel® Core2® series processors; Intel® Celeron series processors; Apple® A series processors; and similar. Unless described otherwise, the construction and operation of the various blocks shown in FIG. 3 are of conventional design. As a result, such blocks need not be described in further detail herein, as they will be understood by those skilled in the relevant art. The communications link 316 that interconnects at least some of the components of the processor-based device 302 may employ any known serial or parallel bus structures or architectures.

The system memory 314 may include read-only memory (“ROM”) 318 and random access memory (“RAM”) 320. A portion of the ROM 318 may be used to store or otherwise retain a basic input/output system (“BIOS”) 322. The BIOS 322 provides basic functionality to the processor-based device 302, for example by causing the processor circuitry 120 to load one or more machine-readable instruction sets. In embodiments, at least some of the one or more machine-readable instruction sets cause at least a portion of the processor circuitry 120 to provide, create, produce, transition, and/or function as a dedicated, specific, and particular machine, such as collage mode touch processing circuitry 122.

The processor-based device 302 may include one or more communicably coupled, non-transitory, data storage devices 130. The one or more data storage devices 130 may be disposed local to and/or remote from the processor-based device 302. The one or more data storage devices 130 may include any current or future developed storage appliances, networks, and/or devices. Non-limiting examples of such data storage devices 130 may include, but are not limited to, any current or future developed non-transitory storage appliances or devices, such as one or more magnetic storage devices, one or more optical storage devices, one or more solid-state electromagnetic storage devices, one or more electro-resistive storage devices, one or more molecular storage devices, one or more quantum storage devices, or various combinations thereof. In some implementations, the one or more data storage devices 130 may include one or more removable storage devices, such as one or more flash drives, flash memories, flash storage units, or similar appliances or devices capable of communicable coupling to and decoupling from the processor-based device 302.

The one or more storage devices 130 may include interfaces or controllers (not shown) communicatively coupling the respective storage device or system to the communications link 316. The one or more storage devices 130 may contain machine-readable instruction sets, data structures, program modules, data stores, databases, logical structures, and/or other data useful to the processor circuitry 120 and/or the collage mode touch processing circuitry 122. In some instances, one or more external storage devices 130 may be communicably coupled to the processor circuitry 120, for example via communications link 316 or via one or more wired communications interfaces (e.g., Universal Serial Bus or USB); one or more wireless communications interfaces (e.g., Bluetooth®, Near Field Communication or NFC); one or more wired network interfaces (e.g., IEEE 802.3 or Ethernet); and/or one or more wireless network interfaces (e.g., IEEE 802.11 or WiFi®).

Machine-readable instruction sets 338 and other instruction sets, logic instructions, and/or modules 340 may be stored in whole or in part in the system memory 314. Such instruction sets 338 may be transferred to the system memory 314, in whole or in part, from one or more sources, such as one or more internal data storage devices 332 (e.g., caches) and/or the storage device 130. The instruction sets 338 may be loaded, stored, or otherwise retained in system memory 120, in whole or in part, during execution by the processor circuitry 120. The machine-readable instruction sets 338 may include machine-readable and/or processor-readable code, instructions, or similar logic capable of providing the collage mode touch processing and other capabilities described herein.

For example, the one or more machine-readable instruction sets 338 may cause the video processing circuitry 104 to generate one or more calibration patterns on at least two touchscreen devices 110A, 110B to receive user input sufficient to determine one or more unique display parameters (e.g., bezel widths of adjacent touchscreen devices) responsive to receipt of a request to enter a collage display mode. The one or more machine-readable instruction sets 338 may cause the video processing circuitry 104 to apportion the scene 102 provided by an application 140 between the at least two touchscreen devices 110A, 110B using the collage display mode as described herein.

Additionally, the one or more machine-readable instruction sets 338 may cause the collage mode touch processing circuitry 122 to receive one or more signals including information and/or data indicative of the processor-based device 302 being placed in a collage display mode. to machine-readable instruction sets 338 may cause the collage mode touch processing circuitry 122 to Further, the one or more machine-readable instruction sets 338 may cause the collage mode touch processing circuitry 122 to receive one or more signals including information and/or data indicative of a unique identifier associated with a touchscreen device 110 on which a touch event 150 has occurred. The one or more machine-readable instruction sets 338 may cause the collage mode touch processing circuitry 122 to receive one or more signals including information and/or data indicative of a local coordinates (X_{LOCAL}, Y_{LOCAL}) of the touch event 150 on the respective touchscreen device 110. The one or more machine-readable instruction sets 338 may further cause the collage mode touch processing circuitry 122 to determine the global coordinates (X_{GLOBAL}, Y_{GLOBAL}) of a touch event 150 on one of a plurality of touchscreen devices 110A-110n operating in collage display mode. The one or more machine-readable instruction sets 338 may further cause the collage mode touch processing circuitry 122 to generate one or more signals that include information and/or data indicative of the global coordinates (X_{GLOBAL}, Y_{GLOBAL}) of a touch event 150 on one of a plurality of touchscreen devices 110A-110n operating in collage display mode. The one or more machine-readable instruction sets 338 may further cause the collage mode touch processing circuitry 122 to communicate to the application 140 and/or operating system 336 one or more signals that include information and/or data indicative of the global coordinates (X_{GLOBAL}, Y_{GLOBAL}) of a touch event 150 on one of a plurality of touchscreen devices 110A-110n operating in collage display mode.

Device users may provide, enter, or otherwise supply commands (e.g., selections, acknowledgements, confirmations, and similar) as well as information and/or data (e.g., switch to collage display mode, touchscreen device information, and similar) to the processor-based device 302 using one or more communicably coupled input devices 350 such as one or more text entry devices 351 (e.g., keyboard), one or more pointing devices 352 (e.g., mouse, trackball, touchscreen), and/or one or more audio input devices 353. Some or all of the physical input devices 350 may include a wired or a wireless communicable coupling to the processor-based device 302. In some implementations, pointer output from the touchscreen devices 110A-110n may be communicated to the processor-based device 302 and to the collage mode touch processing circuitry 122 via one or more I/O interfaces 382. Such I/O interfaces 382 may include, but are not limited to, one or more wired or wireless interfaces, for example via one or more universal serial bus (USB) interfaces, one or more Thunderbolt® interfaces, one or more near field communication (NFC) wireless interfaces, one or more Bluetooth® wireless interfaces, or similar.

Processor-based device users may receive output from the processor-based device 302 via one or more output devices 354. In at least some implementations, the one or more output devices 354 may include, but are not limited to, one or more: video output or display devices 355; tactile output devices 356; audio output devices 357, or combinations thereof. Some or all of the input devices 350 and some or all of the output devices 354 may be communicably coupled to the processor-based device 302 via one or more wired or wireless interfaces. In some implementations, video output from the video processing circuitry 104 may be communicated to the at least two touchscreen devices 110A, 110B operated in the collage display mode via one or more video output interfaces 385. Such video output interfaces 382 may include, but are not limited to: a high definition multimedia interface (HDMI) interface, a digital video interface (DVI); a video graphics array (VGA) interface; a Thunderbolt® interface; or similar.

For convenience, a network interface 360, the video processing circuitry 104, the processor circuitry 120, the system memory 314, the input devices 350 and the output devices 354 are illustrated as communicatively coupled to each other via the communications link 316, thereby providing connectivity between the above-described components. In alternative embodiments, the above-described components may be communicatively coupled in a different manner than illustrated in FIG. 3. For example, one or more of the above-described components may be directly coupled to other components, or may be coupled to each other, via one or more intermediary components (not shown). In some embodiments, all or a portion of the communications link 316 may be omitted and the components are coupled directly to each other using suitable wired or wireless connections.

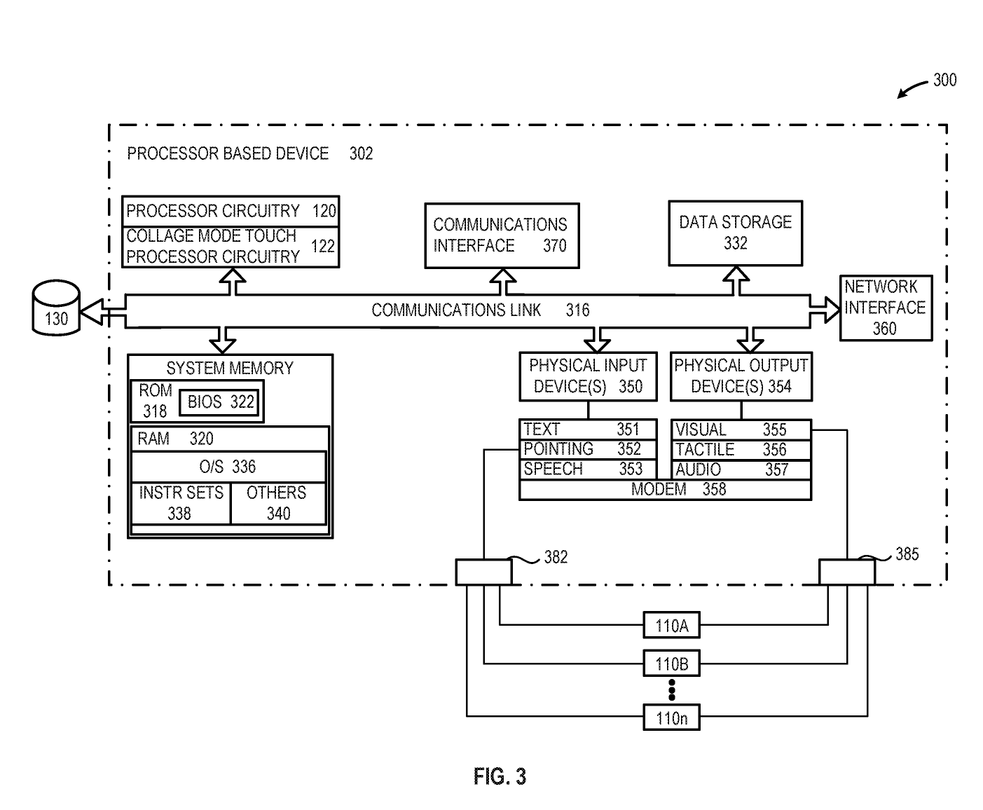

FIG. 4A is an elevation view of an illustrative system 400A in which two touchscreen devices 110A, 110B that are not operated in collage display mode, in accordance with at least one embodiment described herein. FIG. 4B is an elevation view of the illustrative system 400A in which the two touchscreen devices 110A, 110B are operated in a collage display mode to enable the collage mode touch processing circuitry 122 to determine the global coordinates (X_{GLOBAL}, Y_{GLOBAL}) of a touch event 150, in accordance with at least one embodiment described herein.

As depicted in FIG. 4A, a touch event 150 occurs at a point in the center of the second (i.e., rightmost) touchscreen device 110B. Assuming a touch resolution of 100×50 for the second touchscreen device 110B, the local coordinates (X_{LOCAL}, Y_{LOCAL}) of the touch event 150 are (x/2, y/2) or (100/2=50, 50/2=25). The collage mode touch processing circuitry 122 maps the location of the touch event 150 to a unique location on the at least two touchscreen devices 110A, 110B using a global coordinate system spanning the at least two touchscreen devices 110A, 110B. Using the horizontally aligned touchscreen devices 110A, 110B depicted in FIG. 4B, and assuming the horizontal touch resolution (X_{TOUCH}=100) and vertical touch resolution (Y_{TOUCH}=50) for both touchscreen devices 110A and 110B, the collage mode touch processing circuitry 122 may determine the global coordinates (X_{GLOBAL}, Y_{GLOBAL}) of the touch event 150 as follows:

X_{GLOBAL}=X_{LOCAL}+((TOUCHSCREENID−1)*X_{TOUCH})) (9)

X_{GLOBAL}=50+((2−1)*100)=150

Y_{GLOBAL}=Y_{LOCAL} (10)

Y_{GLOBAL}=50

where: X_{LOCAL}=local x coordinate of touch event 150
Y_{LOCAL}=local y coordinate of touch event 150
X_{GLOBAL}=global x coordinate of touch event 150
Y_{GLOBAL}=global y coordinate of touch event 150
X_{TOUCH}=local touchscreen device touch resolution in X direction

Thus, using the global coordinates (X_{GLOBAL}, Y_{GLOBAL}) as received from the collage mode touch processing circuitry 122, the application 140 may correlate the touch event with a unique location on one or more items or objects included in the scene 102 and displayed on the at least two touchscreen devices 110A, 110B.

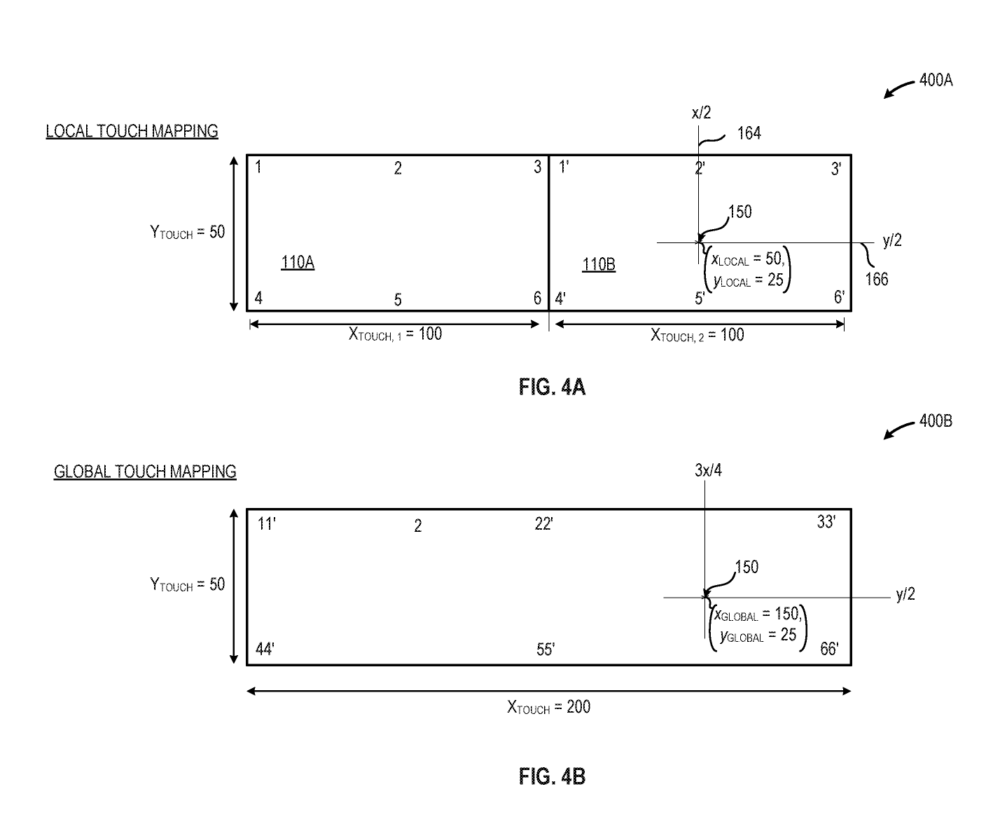

FIG. 5 is a system diagram depicting an illustrative system 500 that includes interfaces for providing a collage display mode input selector and collage mode touch processing circuitry 122 to intercept and convert local touch event location coordinates (X_{LOCAL}, Y_{LOCAL}) and touchscreen device information to global touch event location coordinates (X_{GLOBAL}, Y_{GLOBAL}) prior to forwarding the global touch event location coordinates (X_{GLOBAL}, Y_{GLOBAL}) from kernel ring 0 to user ring 3, in accordance with at least one embodiment described herein. As depicted in FIG. 5, the equipment controller (“EC”) 502 provides a DOCK/UNDOCK state event indicator 504 to provide information and/or data to a display manager service and mode selection user interface 518 regarding whether the system 500 is coupled to a docking station or similar device providing access to external and/or peripheral equipment. The EC 502 similarly provides DISPLAY MODE button 506 as a general purpose I/O input to the display manager service and mode selection user interface 518.

When the system 500 is placed in a display mode other than a collage display mode, the collage mode touch processing circuitry 122 is bypassed 550 and the local touch event coordinates (X_{LOCAL}, Y_{LOCAL}) obtained from one of a plurality of communicably coupled touchscreen devices 110 are forwarded directly from the human interface devices (“HID”) class driver 544 in kernel ring 0 to the HID Clients 546 and thence to one or more applications 140 executing in user ring 3. When the system 500 is placed in the collage display mode, the collage mode touch processing circuitry 122 is included between the HID class driver 544 in kernel ring 0 to the HID Clients 546 such that the local touch event coordinates (X_{LOCAL}, Y_{LOCAL}) are converted to global touch event coordinates (X_{GLOBAL}, Y_{GLOBAL}) prior to forwarding the global touch event coordinates (X_{GLOBAL}, Y_{GLOBAL}) to the HID Clients 546 and thence to one or more applications 140 executing in user ring 3.

As depicted in FIG. 5, the BIOS 322 may include a DOCK/UNDOCK state event handler 508 to receive information regarding the status of the DOCK/UNDOCK state 504. The BIOS 322 may additionally include a DISPLAY MODE button handler to receive information regarding the DISPLAY MODE button 506. The BIOS 322 communicates some or all of the received information to the advanced configuration and power interface (“ACPI”) class driver 512. In embodiments, the ACPI class driver 512 communicates dock state information to the video processing circuitry 104 and to the display manager service and mode selection user interface 518. In embodiments, the ACPI class driver 512 communicates display mode button event status to the HID event driver 516, which in turn communicates the display mode button event status to the HID clients 546 and to the display manager service and mode selection user interface 518.

In response to receipt of DISPLAY MODE button status indicative of a manually received or automatically generated command to place the system 500 in collage display mode, the display manager service and mode selection user interface 518 communicates a signal 106 to the video processing circuitry 104 that causes the video processing circuitry 104 to apportion the scene 102 between the at least two touchscreen devices 110A, 110B that are operating in collage display mode. In response to receipt of DISPLAY MODE button status indicative of a manually received or automatically generated command to place the system 500 in collage display mode, the display manager service and mode selection user interface 518 may further communicate a signal to the HID clients 546 that places the collage mode touch processing circuitry 122 in collage display mode, thereby causing the collage mode touch processing circuitry 122 to convert local touch coordinates (X_{LOCAL}, Y_{LOCAL}) to global touch coordinates (X_{GLOBAL}, Y_{GLOBAL}). The global touch coordinates (X_{GLOBAL}, Y_{GLOBAL}) are communicated from the collage mode touch processing circuitry 122 to the HID clients 546. In embodiments, the HID clients 546 provide one or more signals 124 containing the global coordinates (X_{GLOBAL}, Y_{GLOBAL}) of the touch event 150 to one or more applications 140 when the system 500 is placed in the collage display mode. In embodiments, the HID clients 546 provide one or more signals 124 containing the local coordinates (X_{LOCAL}, Y_{LOCAL}) of the touch event 150 to one or more applications 140 when the system 500 is placed in any other display mode than the collage display mode.

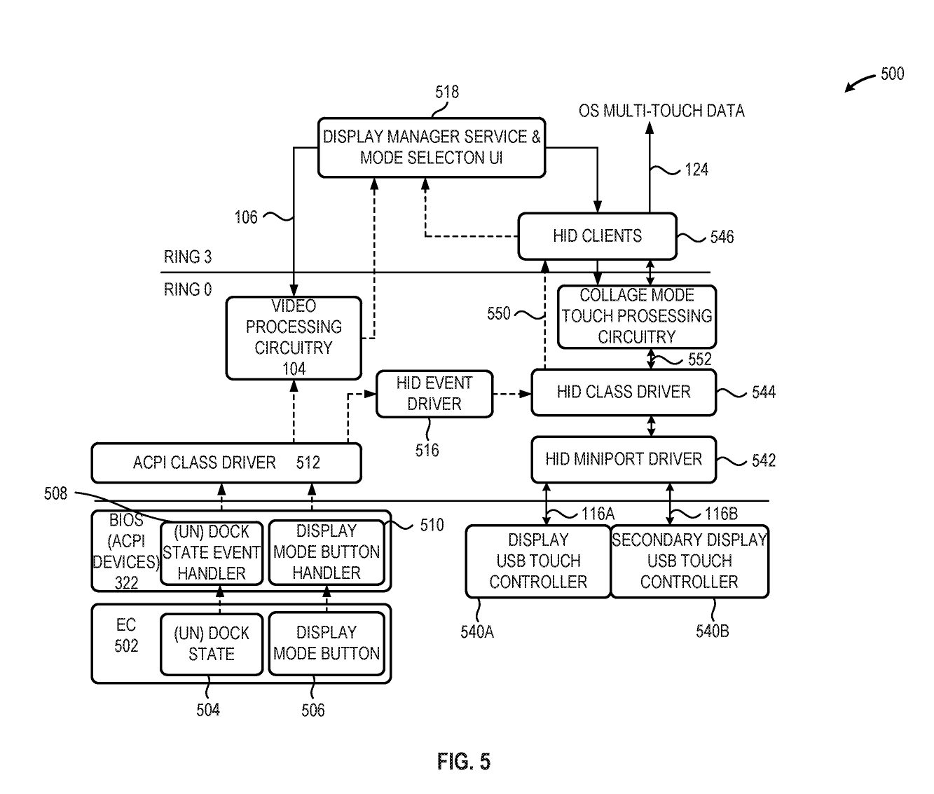

FIG. 6 is a high-level logic flow diagram of an illustrative method 600 of translating or otherwise converting local coordinates (X_{LOCAL}, Y_{LOCAL}) associated with a touch event 150 on one of at least two touchscreen devices 110A, 100B used to provide an image of a scene in a collage display mode, in accordance with at least one embodiment described herein. The collage display mode advantageously improves the resolution of a scene 102 and beneficially enables the use of at least two relatively low cost touchscreen devices 110A, 110B to display the scene 102 apportioned between the at least two touchscreen devices 110. The method 600 commences at 602.

At 604, the collage mode touch processing circuitry 122 determines a respective touch input resolution (X_{TOUCH} and Y_{TOUCH}) for each of the at least two touchscreen devices 110A and 110B used to provide the collage display mode.

At 606, the collage mode touch processing circuitry 122 translates local coordinates (X_{LOCAL}, Y_{LOCAL}) of a touch event 150 that has occurred on one of the at least two touchscreen devices 110 to global coordinates (X_{GLOBAL}, Y_{GLOBAL}) in a global coordinate system that spans, encompasses, covers, or otherwise stretches across at least a portion of each of the at least two touchscreen devices 110A and 110B. The collage mode touch processing circuitry 122 may then communicate the determined global coordinates (X_{GLOBAL}, Y_{GLOBAL}) to one or more applications 140 executed by the processor-based device that includes the collage mode touch processing circuitry 122. The method 600 concludes at 608.

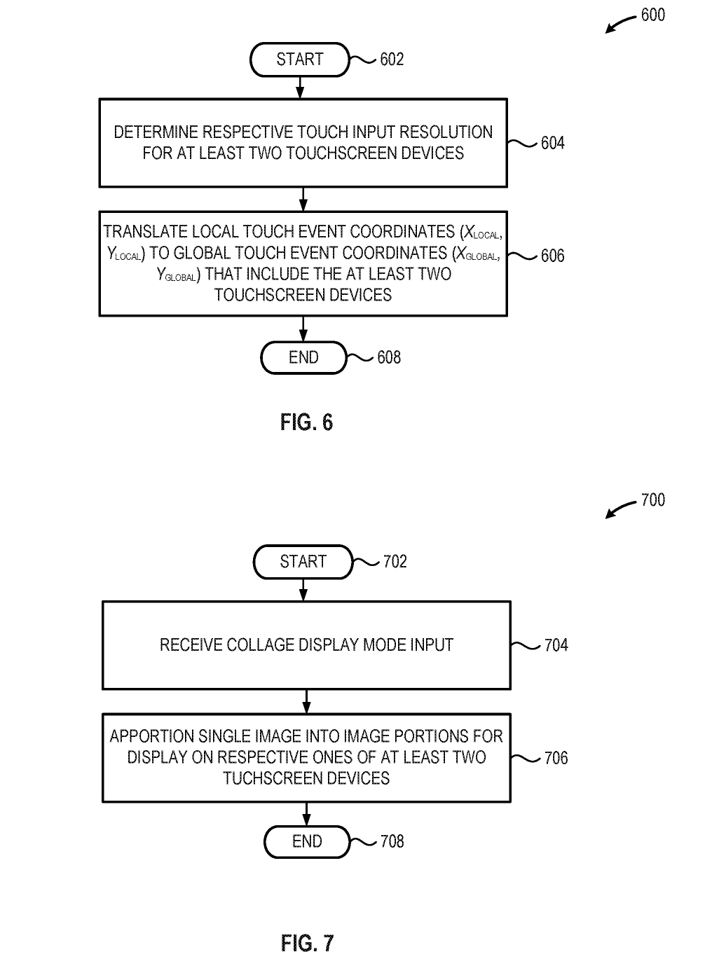

FIG. 7 is a high-level logic flow diagram of an illustrative method 700 of apportioning a single scene 102 into a number of image portions for display on at least two touchscreen devices 110A, 110B in a collage display mode, in accordance with at least one embodiment described herein. The method 700 may be used in conjunction with the method 600 as depicted in FIG. 6 and previously discussed in detail. The method 700 commences at 702.

At 704, video processing circuitry 104 receives a collage display mode input signal 106. In embodiments, the collage display mode input signal 106 may be generated manually, such as by a system user providing one or more system inputs indicative of a desire to place the system into the collage display mode. In embodiments, the collage display mode input signal 106 may be generated automatically, for example by the system O/S in response to one or more defined user actions. For example, collage display mode may be used when a user places the at least two touchscreen devices 110A and 110B in a physical configuration in which the touchscreen devices are aligned either along a common horizontal axis or a common vertical axis. In embodiments, the collage display mode input signal 106 may be generated by one or more applications 140 executed by the system. For example, a media presentation application may cause the system to autonomously enter collage display mode.

At 706, responsive to receiving the collage display mode input signal, the video processing circuitry 104 apportions a single scene 102 into image portions, each of which is displayed on a respective one of the at least two touchscreen devices 110A and 110B. In implementations, the single scene 102 may include any number of sequential single scenes 102A-102n provided at a frame rate that forms a video or similar moving picture presentation. In implementations, each of the single scenes 102 may include multiple images—for example as a scene in a stereoscopic or virtual reality presentation. The method 700 concludes at 708.

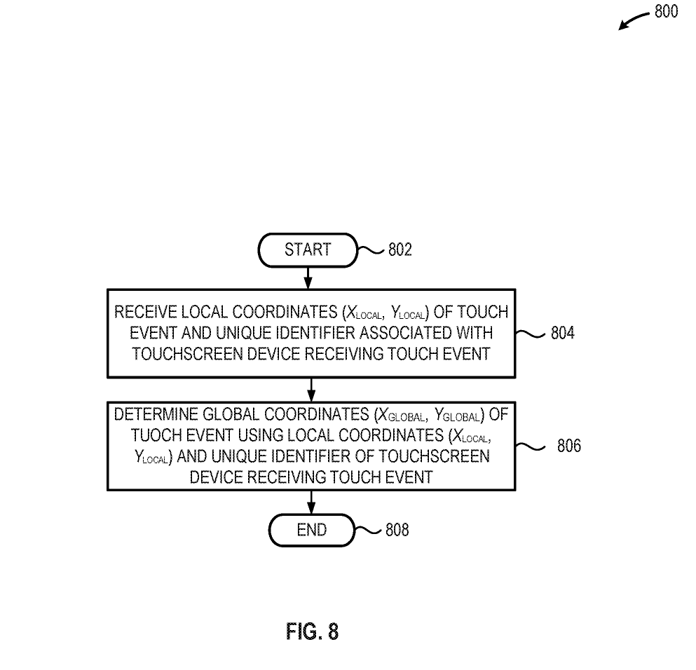

FIG. 8 is a high-level flow diagram of an illustrative method 800 of determining global coordinates (X_{GLOBAL}, Y_{GLOBAL}) using local coordinates (X_{LOCAL}, Y_{LOCAL}) of a touch event 150 that has occurred on one of the at least two touchscreen devices 110A and 110B, in accordance with at least one embodiment described herein. The method 800 may be used in conjunction with either or both the method 600 as depicted in FIG. 6 and/or the method 700 as depicted in FIG. 7 as both have been previously discussed in detail. The method 800 commences at 802.

At 804, the collage mode touch processing circuitry 122 receives one or more signals 116A, 116B that include a unique identifier associated with one of the at least two touchscreen devices 110A, 110B on which a touch event 150 has occurred. The collage mode touch processing circuitry 122 also receives one or more signals (which may be the same signal carrying the unique identifier of associated with one of the at least two touchscreen devices) that includes local coordinates (X_{LOCAL}, Y_{LOCAL}) of the touch event 150 that has occurred on one of the at least two touchscreen devices 110A, 110B.

At 806, the collage mode touch processing circuitry 122, using the unique identifier and local coordinates (X_{LOCAL}, Y_{LOCAL}) received at 804, determines the global coordinates (X_{GLOBAL}, Y_{GLOBAL}) of the touch event 150. The global coordinates (X_{GLOBAL}, Y_{GLOBAL}) map to a global coordinate system 170 that spans, covers, or otherwise extends across at least a portion of the at least two touchscreen devices 110A and 110B. The method 800 concludes at 808.

While FIGS. 6, 7, and 8 illustrate various operations according to one or more embodiments, it is to be understood that not all of the operations depicted in FIGS. 6, 7, and 8 are necessary for other embodiments. Indeed, it is fully contemplated herein that in other embodiments of the present disclosure, the operations depicted in FIGS. 6, 7, and 8 and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to systems and methods for autonomously determining global coordinates of touch events using at least two touchscreen devices configured to display a scene in a collage display mode. The systems and methods disclosed herein include video processing circuitry to receive the scene and apportion the scene into image portions, each of which is displayed on a respective one of the at least two touchscreen devices. The collage display mode beneficially provides enhanced resolution, greater fluidity, and less disruption or discontinuities as objects and/or moving objects included in the scene transition between touchscreen devices. The systems and methods disclosed herein employ collage mode touch processing circuitry that beneficially permits the use of a touchscreen input on the at least two touchscreen devices by converting local touch coordinates associated with a touch event on one of the at least two touchscreen devices to global coordinates associated with the touch event where the global coordinates use a global coordinate system that spans, covers, or extends across the at least two touchscreen devices. Such global coordinates may be mapped to objects included in the scene to enable touchscreen functionality even when the touchscreen devices are used in a collage display mode.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for determining global coordinates associated with a touch event using a global coordinate system extending across at least two touchscreen devices, each of which includes a respective image portion of a single scene or image displayed in a collage display mode.

According to example 1, there is provided a system to provide scaled touchscreen inputs across a plurality of display devices when in a collage mode. The system may include processor circuitry to couple to a plurality of touchscreen devices, at least two of the plurality of touchscreen devices to receive respective portions of an image, the at least two touchscreen devices to present the respective portions of the image in a collage mode; a storage device that includes instructions that, when executed by the processor circuitry, cause at least a portion of the processor circuitry to provide collage mode touch processing circuitry, the collage mode touch processing circuitry to, responsive to receipt of an input indicative of a collage mode display: determine a touch input resolution for each touchscreen device included in the plurality of touchscreen devices; and translate local coordinates (X_{LOCAL}, Y_{LOCAL}) of a touch event on one of the at least two touchscreen displays to global coordinates (X_{GLOBAL}, Y_{GLOBAL}) in a global coordinate system covering at least a portion of the at least two touchscreen devices.

Example 2 may include elements of example 1 and the system may further include video processing circuitry communicably coupled to the processor circuitry and the plurality of touchscreen devices, the video processing circuitry to apportion the image across the at least two touchscreen devices.

Example 3 may include elements of example 1 and the system may further include at least one input/output (I/O) interface communicably coupled to the processor circuitry, the I/O interface to receive at least one touch signal that includes information indicative of a location of a touch event on one of the at least two touchscreen devices.

Example 4 may include elements of example 3 where the collage mode touch processing circuitry communicates information indicative of the global coordinates (X_{GLOBAL}, Y_{GLOBAL}) of the touch event to an application executed by the processor circuitry.

Example 5 may include elements of example 3 where the at least one touch signal includes a multitouch signal that further includes information indicative of multitouch event on one of the at least two touchscreen devices; and where the collage mode touch processing circuitry may further determine the number of touches at the location of the multitouch event; and the global coordinates (X_{GLOBAL}, Y_{GLOBAL}) of the multitouch event.

Example 6 may include elements of example 5 where the at least one touch signal includes a gesture signal that further includes information indicative of a gesture event on one of the at least two touchscreen devices; and where the collage mode touch processing circuitry may further determine: the location of the gesture event on the one of the at least two touchscreen devices; the number of touches at the location of the gesture event; and the global coordinates (X_{GLOBAL}, Y_{GLOBAL}) of the gesture event.

Example 7 may include elements of example 3 where the at least one touch signal includes a gesture signal that further includes information indicative of a gesture event on one of the at least two touchscreen devices; and where collage mode touch processing circuitry further determines: the gesture at the location of the gesture event; and the global coordinates (X_{GLOBAL}, Y_{GLOBAL}) of the gesture event.

Example 8 may include elements of example 1 and the system may further include an input coupled to the processor circuitry to receive at least one of: a manually generated collage display mode input or an autonomously generated display mode input.

Example 9 may include elements of example 1 where the at least two of the plurality of touchscreen devices have the same horizontal (“X”) and vertical (“Y”) resolution.

Example 10 may include elements of example 9 where the at least two of the plurality of touchscreen devices include a first touchscreen device and a second touchscreen device; where the image is displayed in a collage display mode in which a first portion of the image is displayed on the first touchscreen device and a second portion of the image is displayed on the second touchscreen device; and where the collage mode touch processing circuitry assigns a touchscreen identifier equal to 1 (TOUCHID=1) to the first touchscreen device and a touchscreen identifier equal to 2 (TOUCHID=2) to the second touchscreen device.

Example 11 may include elements of example 10 where the first touchscreen device and the second touchscreen device are arranged along a common horizontal axis; and where the collage mode touch processing circuitry determines a horizontal global coordinate (X_{GLOBAL}) of a touch event on either the first touchscreen device or the second touchscreen device using the equation: X_{GLOBAL}=X_{LOCAL}+((TOUCHID−1)*X_{TOUCH}).

Example 12 may include elements of example 10 where the first touchscreen device and the second touchscreen device are arranged along a common vertical axis; and where the collage mode touch processing circuitry determines a vertical global coordinate (Y_{GLOBAL}) of a touch event on either the first touchscreen device or the second touchscreen device using the equation: Y_{GLOBAL}=Y_{LOCAL}+((TOUCHID−1)*Y_{TOUCH}).

According to example 13, there is provided a method to identify the location of a touch event on one of a plurality of touchscreen devices. The method may include determining, via collage mode touch processing circuitry, a respective touch input resolution for each of a plurality of communicably coupled touchscreen devices, at least two of the touchscreen devices to receive respective portions of an image, the at least two touchscreen devices to present respective portions of an image in a collage mode; and translating local coordinates of a touch event on one of the at least two touchscreen devices to global coordinates (X_{GLOBAL}, Y_{GLOBAL}) in a global coordinate system covering at least a portion of the at least two touchscreen devices.

Example 14 may include elements of example 13, and the method may further include receiving, via video processing circuitry communicably coupled to the collage mode touch processing circuitry, a collage display mode input; and apportioning, via the video processing circuitry, the image into portions, each of the portions for display on a respective one of the at least two touchscreen devices.

Example 15 may include elements of example 14, and the method may further include receiving, via the collage mode touch processing circuitry, a touch signal that includes at least: local coordinates of the touch event on one of the at least two touchscreen devices; and a unique identifier corresponding to the one of the at least two touchscreen devices.

Example 16 may include elements of example 15, and the method may further include determining, via the collage mode touch processing circuitry, the global coordinates (X_{GLOBAL}, Y_{GLOBAL}) of the touch event in the global coordinate system using the local coordinates (X_{LOCAL}, Y_{LOCAL}) of the touch event on the one of the at least two touchscreen devices and the unique identifier corresponding to the one of the at least two touchscreen devices.

Example 17 may include elements of example 15 where receiving a touch signal that includes at least: local coordinates (X_{LOCAL}, Y_{LOCAL}) of the touch event on one of the at least two touchscreen devices may further include receiving, by the collage mode touch processing circuitry, a multitouch signal that further includes: information indicative of a multitouch event occurrence on one of the at least two touchscreen devices; and the unique identifier corresponding to the one of the at least two touchscreen devices; and determining, by the collage mode touch processing circuitry: the number of touches at the location of the multitouch event; and the global coordinates (X_{GLOBAL}, Y_{GLOBAL}) of the multitouch event using: the received local coordinates (X_{LOCAL}, Y_{LOCAL}) of the multitouch event; and the received unique identifier.

Example 18 may include elements of example 17 where receiving a touch signal that includes at least: local coordinates of the touch event on one of the at least two touchscreen devices may further include receiving, by the collage mode touch processing circuitry, a gesture signal that further includes information indicative of a gesture event occurrence on one of the at least two touchscreen devices; and the unique identifier corresponding to the one of the at least two touchscreen devices; and determining, by the collage mode touch processing circuitry: the number of touches at the location of the gesture event; and the global coordinates (X_{GLOBAL}, Y_{GLOBAL}) of the gesture event using: the received local coordinates (X_{LOCAL}, Y_{LOCAL}) of the gesture event; and the received unique identifier.

Example 19 may include elements of example 13 where determining a respective touch input resolution for each of a plurality of communicably coupled touchscreen devices may further include determining, via collage mode touch processing circuitry, whether the at least two touchscreen devices have at least one of: the same horizontal (“X_{TOUCH}”) resolution; or the same vertical (“Y_{TOUCH}”) resolution.

Example 20 may include elements of example 19 where translating local coordinates of a touch event occurrence on one of the plurality of communicably coupled touchscreen devices to global coordinates (X_{GLOBAL}, Y_{GLOBAL}) in a global coordinate system that includes at least two of the plurality of communicably coupled touchscreen devices may further include assigning, via the collage mode touch processing circuitry, a touchscreen identifier equal to 1 (TOUCHID=1) to a first touchscreen device included in the at least two touchscreen devices and a touchscreen identifier equal to 2 (TOUCHID=2) to the second touchscreen device included in the at least two touchscreen devices.

Example 21 may include elements of example 20 where, responsive to a determination that the at least two touchscreen devices have the same horizontal touch resolution (“X_{TOUCH}”), determining a respective touch input resolution for each of a plurality of communicably coupled touchscreen devices may further include determining, via collage mode touch processing circuitry, that the at least two touchscreen devices are aligned along a common horizontal (“X”) axis; and where translating local coordinates (X_{LOCAL}, Y_{LOCAL}) of a touch event on one of the at least two touchscreen devices to global coordinates (X_{GLOBAL}, Y_{GLOBAL}) in a global coordinate covering at least a portion of the at least two touchscreen devices may further include determining, via the collage mode touch processing circuitry, a horizontal global coordinate (X_{GLOBAL}) of a touch event using the equation: X_{GLOBAL}=X_{LOCAL}+((TOUCHID−1)*X_{TOUCH}).

Example 22 may include elements of example 20 where, responsive to a determination that the at least two touchscreen devices have the same vertical touch resolution (“Y_{TOUCH}”), determining a respective touch input resolution for each of a plurality of communicably coupled touchscreen devices may further include determining, via collage mode touch processing circuitry, that the at least two touchscreen devices are aligned along a common vertical (“Y”) axis; and where translating local coordinates (X_{LOCAL}, Y_{LOCAL}) of a touch event on one of the at least two touchscreen devices to global coordinates (X_{GLOBAL}, Y_{GLOBAL}) in a global coordinate covering at least a portion of the at least two touchscreen devices may further include determining, via the collage mode touch processing circuitry, a vertical global coordinate (Y_{GLOBAL}) of a touch event using the equation: Y_{GLOBAL}=Y_{LOCAL}+((TOUCHID−1)*Y_{TOUCH}).

According to example 23, there is provided a collage mode touch controller. The controller may include a collage mode touch processing circuitry to: determine a touch input resolution for each of a plurality of communicably coupled touchscreen devices; and translate local coordinates (X_{LOCAL}, Y_{LOCAL}) of a touch event on one of at least two of the plurality of touchscreen devices to global coordinates (X_{GLOBAL}, Y_{GLOBAL}) in a global coordinate system that covers the at least two touchscreen devices, the at least two touchscreen devices to present respective portions of an image in a collage mode.

Example 24 may include elements of example 23 and the controller may further include an input to receive at least one touch signal that includes information indicative of the local coordinates (X_{LOCAL}, Y_{LOCAL}) of the touch event on the one of the at least two touchscreen devices.

Example 25 may include elements of example 24 and the controller may further include an output to communicate information indicative of the global coordinates (X_{GLOBAL}, Y_{GLOBAL}) of the touch event to an application executed by the processor circuitry.

Example 26 may include elements of example 24 where the at least one touch signal includes a multitouch signal that may further include information indicative of a number of touches on the one of the at least two touchscreen devices; and where the collage mode touch processing circuitry may further determine: the number of touches at the location of the multitouch event; and the global coordinates (X_{GLOBAL}, Y_{GLOBAL}) of the multitouch event.

Example 27 may include elements of example 26 where the at least one touch signal includes a gesture signal that further includes information indicative of a gesture on the one of the at least two touchscreen devices; and where the collage mode touch processing circuitry further determines: the number of touches at the location of the gesture event; and the global coordinates (X_{GLOBAL}, Y_{GLOBAL}) of the gesture event.

Example 28 may include elements of example 24 where the at least one touch signal includes a gesture signal that further includes information indicative of a gesture on the one of the at least two touchscreen devices; and where the collage mode touch processing circuitry further determines: the number of touches at the location of the gesture event; and the global coordinates (X_{GLOBAL}, Y_{GLOBAL}) of the gesture event.

Example 29 may include elements of example 24 where, responsive to determining a first communicably coupled touchscreen device and a second communicably coupled touchscreen device have the same horizontal (“X_{TOUCH}”) and vertical (“Y_{TOUCH}”) touch resolution, the collage mode touch processing circuitry assigns a touchscreen identifier equal to 1 (TOUCHID=1) to the first touchscreen device and a touchscreen identifier equal to 2 (TOUCHID=2) to the second touchscreen device.

Example 30 may include elements of example 29 where, responsive to determining a first communicably coupled touchscreen device and a second communicably coupled touchscreen device are arranged along a common horizontal axis, the collage mode touch processing circuitry: determines a horizontal global coordinate (X_{GLOBAL}) of the touch event on either the first touchscreen device or the second touchscreen device using the equation: X_{GLOBAL}=X_{LOCAL}+((TOUCHID−1)*X_{TOUCH}).

Example 31 may include elements of example 29 where, responsive to determining a first communicably coupled touchscreen device and a second communicably coupled touchscreen device are arranged along a common vertical axis, the collage mode touch processing circuitry: determines a vertical global coordinate (Y_{GLOBAL}) of the touch event on either the first touchscreen device or the second touchscreen device using the equation: Y_{GLOBAL}=Y_{LOCAL}+((TOUCHID−1)*Y_{TOUCH}).

According to example 32, there is provided a non-transitory computer readable medium that includes instructions. The instructions, when executed, may cause collage mode touch processing circuitry to: determine a respective touch input resolution (X_{TOUCH}, Y_{TOUCH}) for each of a plurality of communicably coupled touchscreen devices, at least two of the touchscreen devices to receive respective portions of an image, the at least two touchscreen devices to present respective portions of an image in a collage mode; and translate local coordinates (X_{LOCAL}, Y_{LOCAL}) of a touch event on one of the at least two touchscreen devices to global coordinates (X_{GLOBAL}, Y_{GLOBAL}) in a global coordinate system that covers at least a portion of the at least two touchscreen devices.

Example 33 may include elements of example 32 where the instructions may further cause the collage mode touch processing circuitry to: receive, via video processing circuitry communicably coupled to the collage mode touch processing circuitry, a collage display mode input; and apportion the image into the respective portions, each of the portions for display on a one of the at least two touchscreen devices, responsive to receipt of the collage display mode input.

Example 34 may include elements of example 33 where the instructions may further cause the collage mode touch processing circuitry to: receive a touch signal that includes information indicative of at least: local coordinates (X_{LOCAL}, Y_{LOCAL}) of the touch event on one of the at least two touchscreen devices; and a unique identifier corresponding to the one of the at least two touchscreen devices.

Example 35 may include elements of example 34 where the instructions may further cause the collage mode touch processing circuitry to: determine global coordinates (X_{GLOBAL}, Y_{GLOBAL}) of the touch event in the global coordinate system using the local coordinates (X_{LOCAL}, Y_{LOCAL}) of the touch event on the one of the at least two touchscreen devices and the unique identifier corresponding to the one of the at least two touchscreen devices.

Example 36 may include elements of example 34 where the instructions may further cause the collage mode touch processing circuitry to: receive a multitouch signal that further includes: information indicative of a multitouch event occurrence on one of the at least two touchscreen devices; and the unique identifier corresponding to the one of the at least two touchscreen devices; and determine the number of touches at the location of the multitouch event and the global coordinates (X_{GLOBAL}, Y_{GLOBAL}) of the multitouch event using: the received local coordinates (X_{LOCAL}, Y_{LOCAL}) of the multitouch event; and the received unique identifier.

Example 37 may include elements of example 36 where the instructions may further cause the collage mode touch processing circuitry to: receive a gesture signal that further includes information indicative of a gesture event occurrence on one of the at least two touchscreen devices; and the unique identifier corresponding to the one of the at least two touchscreen devices; and determine the number of touches at the location of the gesture event; and the global coordinates (X_{GLOBAL}, Y_{GLOBAL}) of the gesture event using: the received local coordinates of the gesture event; and the received unique identifier.

Example 38 may include elements of example 32 where the instructions may further cause the collage mode touch processing circuitry to: determine whether the at least two touchscreen devices have at least one of: the same horizontal (“X_{TOUCH}”) resolution; or the same vertical (“Y_{TOUCH}”) resolution.

Example 39 may include elements of example 38 where the instructions may further cause the collage mode touch processing circuitry to assign a touchscreen identifier equal to 1 (TOUCHID=1) to a first touchscreen device included in the at least two touchscreen devices and a touchscreen identifier equal to 2 (TOUCHID=2) to the second touchscreen device included in the at least two touchscreen devices.

Example 40 may include elements of example 39 where the instructions may further cause the collage mode touch processing circuitry to, responsive to determining the at least two touchscreen devices have the same horizontal touch (“X_{TOUCH}”) resolution: determine that the at least two touchscreen devices are aligned along a common horizontal (“X”) axis; and determine a horizontal global coordinate (X_{GLOBAL}) of a touch event using the equation: X_{GLOBAL}=X_{LOCAL}+((TOUCHID−1)*X_{TOUCH}).

Example 41 may include elements of example 39 where the instructions further cause the collage mode touch processing circuitry to, responsive to determining the at least two touchscreen devices have the same vertical touch (“Y_{TOUCH}”) resolution: determining, via collage mode touch processing circuitry, that the at least two touchscreen devices are aligned along a common vertical (“Y”) axis; and determining, via the collage mode touch processing circuitry, a vertical coordinate (Y_{GLOBAL}) of a touch event using the equation: Y_{GLOBAL}=Y_{LOCAL}+((TOUCHID−1)*Y_{TOUCH}).

According to example 42, there is provided a system to identify the location of a touch event on one of a plurality of touchscreen devices. The system may include a means for determining a respective touch input resolution for each of a plurality of communicably coupled touchscreen devices, at least two of the touchscreen devices to receive respective portions of an image, the at least two touchscreen devices to present respective portions of an image in a collage mode; and a means for translating local coordinates (X_{LOCAL}, Y_{LOCAL}) of a touch event on one of the at least two touchscreen devices to global coordinates (X_{GLOBAL}, Y_{GLOBAL}) in a global coordinate system covering at least a portion of the at least two touchscreen devices.

Example 43 may include elements of example 42 and the system may further include a means for receiving a collage display mode input; and a means for apportioning the image into portions, each of the portions for display on a respective one of the at least two touchscreen devices.

Example 44 may include elements of example 43 and the system may further include a means for receiving a touch signal that includes at least: local coordinates (X_{LOCAL}, Y_{LOCAL}) of the touch event on one of the at least two touchscreen devices; and a unique identifier corresponding to the one of the at least two touchscreen devices.

Example 45 may include elements of example 44 and the system may further include a means for determining the global coordinates (X_{GLOBAL}, Y_{GLOBAL}) of the touch event in the global coordinate system using the local coordinates (X_{LOCAL}, Y_{LOCAL}) of the touch event on the one of the at least two touchscreen devices and the unique identifier corresponding to the one of the at least two touchscreen devices.

Example 46 may include elements of example 44 where the means for receiving a touch signal that includes at least: local coordinates of the touch event on one of the at least two touchscreen devices may further include a means for receiving a multitouch signal that further includes: information indicative of a multitouch event occurrence on one of the at least two touchscreen devices; and the unique identifier corresponding to the one of the at least two touchscreen devices; and a means for determining: the number of touches at the location of the multitouch event; and the global coordinates (X_{GLOBAL}, Y_{GLOBAL}) of the multitouch event using: the received local coordinates of the multitouch event; and the received unique identifier.

Example 47 may include elements of example 46 where the means for receiving a touch signal that includes at least: local coordinates (X_{LOCAL}, Y_{LOCAL}) of the touch event on one of the at least two touchscreen devices may further include a means for receiving a gesture signal that further includes information indicative of a gesture event occurrence on one of the at least two touchscreen devices; and the unique identifier corresponding to the one of the at least two touchscreen devices; and a means for determining: the number of touches at the location of the gesture event; and the global coordinates (X_{GLOBAL}, Y_{GLOBAL}) of the gesture event using the received local coordinates (X_{LOCAL}, Y_{LOCAL}) of the gesture event; and the received unique identifier.

Example 48 may include elements of example 42 where the means for determining a respective touch input resolution for each of a plurality of communicably coupled touchscreen devices may further include a means for determining whether the at least two touchscreen devices have at least one of: the same horizontal (“X_{TOUCH}”) resolution; or the same vertical (“Y_{TOUCH}”) resolution.

Example 49 may include elements of example 48 where the means for translating local coordinates of a touch event occurrence on one of the plurality of communicably coupled touchscreen devices to global coordinates (X_{GLOBAL}, Y_{GLOBAL}) in a global coordinate system that includes at least two of the plurality of communicably coupled touchscreen devices may further include a means for assigning, via the collage mode touch processing circuitry, a touchscreen identifier equal to 1 (TOUCHID=1) to a first touchscreen device included in the at least two touchscreen devices and a touchscreen identifier equal to 2 (TOUCHID=2) to the second touchscreen device included in the at least two touchscreen devices.

Example 50 may include elements of example 49 where the means for determining, responsive to a determination that the at least two touchscreen devices have the same horizontal touch (“X_{TOUCH}”) resolution, a respective touch input resolution for each of a plurality of communicably coupled touchscreen devices may further include a means for determining that the at least two touchscreen devices are aligned along a common horizontal (“X”) axis; and where the means for translating local coordinates (X_{LOCAL}, Y_{LOCAL}) of a touch event on one of the at least two touchscreen devices to global coordinates (X_{GLOBAL}, Y_{GLOBAL}) in a global coordinate system covering at least a portion of the at least two touchscreen devices may further include: a means for determining a horizontal global coordinate (X_{GLOBAL}) of a touch event using the equation: X_{GLOBAL}=X_{LOCAL}+((TOUCHID−1)*X_{TOUCH}).

Example 51 may include elements of example 49 where the means for determining, responsive to a determination that the at least two touchscreen devices have the same vertical touch (“Y_{TOUCH}”) resolution, a respective touch input resolution for each of a plurality of communicably coupled touchscreen devices may further include a means for determining, via collage mode touch processing circuitry, that the at least two touchscreen devices are aligned along a common vertical (“Y”) axis; and where the means for translating local coordinates (X_{LOCAL}, Y_{LOCAL}) of a touch event on one of the at least two touchscreen devices to global coordinates (X_{GLOBAL}, Y_{GLOBAL}) in a global coordinate covering at least a portion of the at least two touchscreen devices may further include a means for determining, via the collage mode touch processing circuitry, a vertical global coordinate (Y_{GLOBAL}) of a touch event using the equation: Y_{GLOBAL}=Y_{LOCAL}+((TOUCHID−1)*Y_{TOUCH}).

According to example 52, there is provided a system for determining global coordinates associated with a touch input on one of at least two touchscreen devices, the system being arranged to perform the method of any of examples 13 through 22.

According to example 53, there is provided a chipset arranged to perform the method of any of examples 13 through 22.

According to example 54, there is provided a non-transitory machine readable medium comprising a plurality of instructions that, in response to be being executed on a computing device, cause the computing device to carry out the method according to any of examples 13 through 22.

According to example 55, there is provided a device configured for determining global coordinates associated with a touch input on one of at least two touchscreen devices, the device being arranged to perform the method of any of examples 13 through 22.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1. A system to provide scaled touchscreen inputs across a plurality of display devices when in a collage mode, the system comprising:
processor circuitry to couple to a plurality of touchscreen devices, at least two of the plurality of touchscreen devices to receive respective portions of an image, the at least two touchscreen devices to present the respective portions of the image in a collage mode;
a storage device that includes instructions that, when executed by the processor circuitry, cause at least a portion of the processor circuitry to provide collage mode touch processing circuitry, the collage mode touch processing circuitry to, responsive to receipt of an input indicative of a collage mode display:
determine a touch input resolution for each touchscreen device included in the plurality of touchscreen devices; and
translate local coordinates (X_{LOCAL}, Y_{LOCAL}) of a touch event on one of the at least two touchscreen displays to global coordinates (X_{GLOBAL}, Y_{GLOBAL}) in a global coordinate system covering at least a portion of the at least two touchscreen devices; and
input/output (I/O) interface circuitry communicatively coupled to the processor circuitry, the I/O interface circuitry to receive a multitouch signal that includes information indicative of the local coordinates (X_{LOCAL}, Y_{LOCAL}) of a touch event on one of the at least two touchscreen devices;
wherein the at least one touch signal includes a multitouch signal that further includes information indicative of multitouch event on one of the at least two touchscreen devices; and
wherein the collage mode touch processing circuitry further determines:
the number of touches at the location of the multitouch event; and
the global coordinates (X_{GLOBAL}, Y_{GLOBAL}) of the multitouch event.

2. The system of claim 1, further comprising:
video processing circuitry communicably coupled to the processor circuitry and the plurality of touchscreen devices, the video processing circuitry to apportion the image across the at least two touchscreen devices.

3. (canceled)

4. The system of claim 1 wherein the collage mode touch processing circuitry communicates information indicative of the global coordinates (X_{GLOBAL}, Y_{GLOBAL}) of the touch event to an application executed by the processor circuitry.

5. (canceled)

6. The system of claim 1:
wherein the at least one touch signal includes a gesture signal that further includes information indicative of a gesture event on one of the at least two touchscreen devices; and
wherein the collage mode touch processing circuitry further determines:
the location of the gesture event on the one of the at least two touchscreen devices;
the number of touches at the location of the gesture event; and
the global coordinates (X_{GLOBAL}, Y_{GLOBAL}) of the gesture event.

7. The system of claim 1:
wherein the at least one touch signal includes a gesture signal that further includes information indicative of a gesture event on one of the at least two touchscreen devices; and
wherein collage mode touch processing circuitry further determines:
the gesture at the location of the gesture event; and
the global coordinates (X_{GLOBAL}, Y_{GLOBAL}) of the gesture event.

8. The system of claim 1, further comprising:
an input coupled to the processor circuitry to receive at least one of: a manually generated collage display mode input or an autonomously generated display mode input.

9. The system of claim 1 wherein the at least two of the plurality of touchscreen devices have the same horizontal (“X_{TOUCH}”) and vertical (“Y_{TOUCH}”) resolution.

10. The system of claim 9:
wherein the at least two of the plurality of touchscreen devices include a first touchscreen device and a second touchscreen device;
wherein the image is displayed in a collage display mode in which a first portion of the image is displayed on the first touchscreen device and a second portion of the image is displayed on the second touchscreen device;
wherein the collage mode touch processing circuitry assigns a touchscreen identifier equal to 1 (TOUCHID=1) to the first touchscreen device and a touchscreen identifier equal to 2 (TOUCHID=2) to the second touchscreen device.

11. The system of claim 10:
wherein the first touchscreen device and the second touchscreen device are arranged along a common horizontal axis; and
wherein the collage mode touch processing circuitry determines a horizontal global coordinate (X_{GLOBAL}) of a touch event on either the first touchscreen device or the second touchscreen device using the equation: X_{GLOBAL}=X_{LOCAL}+((TOUCHID−1)*X_{TOUCH}).

12. The system of claim 10:
wherein the first touchscreen device and the second touchscreen device are arranged along a common vertical axis; and
wherein the collage mode touch processing circuitry determines a vertical global coordinate (Y_{GLOBAL}) of a touch event on either the first touchscreen device or the second touchscreen device using the equation: Y_{GLOBAL}=Y_{LOCAL}+((TOUCHID−1)*Y_{TOUCH}).

13. A method to identify the location of a touch event on one of a plurality of touchscreen devices, the method comprising:
determining, via collage mode touch processing circuitry, a respective touch input resolution for each of a plurality of communicably coupled touchscreen devices, at least two of the touchscreen devices to receive respective portions of an image, the at least two touchscreen devices to present respective portions of an image in a collage mode;
receiving, via the collage mode touch processing circuitry, a touch signal that includes local coordinates (X_{LOCAL}, Y_{LOCAL}) of a touch event on one touchscreen device of the at least two touchscreen devices and a unique identifier corresponding to the one touchscreen device; and
translating local coordinates (X_{LOCAL}, Y_{LOCAL}) of the touch event on the one touchscreen device to global coordinates (X_{GLOBAL}, Y_{GLOBAL}) in a global coordinate system covering at least a portion of the at least two touchscreen devices;
wherein receiving the touch signal that includes the local coordinates (X_{LOCAL}, Y_{LOCAL}) of the touch event includes:
receiving, by the collage mode touch processing circuitry, a multitouch signal that includes information indicative of a multitouch event occurrence on the one touchscreen device and further includes the unique identifier corresponding to the one touchscreen device; and
determining, by the collage mode touch processing circuitry:
the number of touches at the location of the multitouch event; and
the global coordinates (X_{GLOBAL}, Y_{GLOBAL}) of the multitouch event using the received local coordinates (X_{LOCAL}, Y_{LOCAL}) of the multitouch event and the received unique identifier.

14. The method of claim 13, further comprising:
receiving, via video processing circuitry communicably coupled to the collage mode touch processing circuitry, a collage display mode input; and
apportioning, via the video processing circuitry, the image into portions, each of the portions for display on a respective one of the at least two touchscreen devices.

15. (canceled)

16. The method of claim 13, further comprising:
determining, via the collage mode touch processing circuitry, the global coordinates (X_{GLOBAL}, Y_{GLOBAL}) of the touch event in the global coordinate system using the local coordinates (X_{LOCAL}, Y_{LOCAL}) of the touch event on the one of the at least two touchscreen devices and the unique identifier corresponding to the one of the at least two touchscreen devices.

17. (canceled)

18. The method of claim 13 wherein receiving a touch signal that includes at least: local coordinates (X_{LOCAL}, Y_{LOCAL}) of the touch event on one of the at least two touchscreen devices further comprises:
receiving, by the collage mode touch processing circuitry, a gesture signal that further includes information indicative of a gesture event occurrence on one of the at least two touchscreen devices; and the unique identifier corresponding to the one of the at least two touchscreen devices; and
determining, by the collage mode touch processing circuitry:
the number of touches at the location of the gesture event; and
the global coordinates (X_{GLOBAL}, Y_{GLOBAL}) of the gesture event using:
the received local coordinates (X_{LOCAL}, Y_{LOCAL}) of the gesture event; and
the received unique identifier.

19. The method of claim 13 wherein determining a respective touch input resolution for each of a plurality of communicably coupled touchscreen devices further comprises:
determining, via collage mode touch processing circuitry, whether the at least two touchscreen devices have at least one of:
the same horizontal (“X_{TOUCH}”) resolution; or
the same vertical (“Y_{TOUCH}”) resolution.

20. The method of claim 19 wherein translating local coordinates of a touch event occurrence on one of the plurality of communicably coupled touchscreen devices to global coordinates (X_{GLOBAL}, Y_{GLOBAL}) in a global coordinate system that includes at least two of the plurality of communicably coupled touchscreen devices further comprises:
assigning, via the collage mode touch processing circuitry, a touchscreen identifier equal to 1 (TOUCHID=1) to a first touchscreen device included in the at least two touchscreen devices and a touchscreen identifier equal to 2 (TOUCHID=2) to the second touchscreen device included in the at least two touchscreen devices.

21. The method of claim 20:
wherein, responsive to a determination that the at least two touchscreen devices have the same horizontal (“X”) resolution, determining a respective touch input resolution for each of a plurality of communicably coupled touchscreen devices further comprises:
determining, via collage mode touch processing circuitry, that the at least two touchscreen devices are aligned along a common horizontal (“X”) axis; and
wherein translating local coordinates (X_{LOCAL}, Y_{LOCAL}) of a touch event on one of the at least two touchscreen devices to global coordinates (X_{GLOBAL}, Y_{GLOBAL}) in a global coordinate system covering at least a portion of the at least two touchscreen devices further comprises:
determining, via the collage mode touch processing circuitry, a horizontal global coordinate (X_{GLOBAL}) of a touch event using the equation: X_{GLOBAL}=X_{LOCAL}+((TOUCHID−1)*X_{TOUCH}).

22. The method of claim 20:
wherein, responsive to a determination that the at least two touchscreen devices have the same vertical touch (“Y_{TOUCH}”) resolution, determining a respective touch input resolution for each of a plurality of communicably coupled touchscreen devices further comprises:
determining, via collage mode touch processing circuitry, that the at least two touchscreen devices are aligned along a common vertical (“Y”) axis; and
wherein translating local coordinates (X_{LOCAL}, Y_{LOCAL}) of a touch event on one of the at least two touchscreen devices to global coordinates (X_{GLOBAL}, Y_{GLOBAL}) in a global coordinate system covering at least a portion of the at least two touchscreen devices further comprises:
determining, via the collage mode touch processing circuitry, a vertical global coordinate (Y_{GLOBAL}) of a touch event using the equation: Y_{GLOBAL}=Y_{LOCAL}+((TOUCHID−1)*Y_{TOUCH}).

23. A non-transitory computer readable medium that includes instructions that, when executed, cause collage mode touch processing circuitry to:
determine a respective touch input resolution for each of a plurality of communicably coupled touchscreen devices, at least two of the touchscreen devices to receive respective portions of an image, the at least two touchscreen devices to present respective portions of an image in a collage mode;
receive, via the collage mode touch processing circuitry, a touch signal that includes local coordinates (X_{LOCAL}, Y_{LOCAL}) of a touch event on one touchscreen device of the at least two touchscreen devices and a unique identifier corresponding to the one touchscreen device; and
translate local coordinates (X_{LOCAL}, Y_{LOCAL}) of the touch event on the one touchscreen device to global coordinates (X_{GLOBAL}, Y_{GLOBAL}) in a global coordinate system that covers at least a portion of the at least two touchscreen devices;
wherein to receive the touch signal that includes the local coordinates (X_{LOCAL}, Y_{LOCAL}) of the touch event includes to:
receive, by the collage mode touch processing circuitry, a multitouch signal that includes information indicative of a multitouch event occurrence on the one touchscreen device and further includes the unique identifier corresponding to the one touchscreen device; and
determine, by the collage mode touch processing circuitry:
the number of touches at the location of the multitouch event; and
the global coordinates (X_{GLOBAL}, Y_{GLOBAL}) of the multitouch event using the received local coordinates (X_{LOCAL}, Y_{LOCAL}) of the multitouch event and the received unique identifier.

24. The non-transitory computer readable medium of claim 23 wherein the instructions further cause the collage mode touch processing circuitry to:
receive, via video processing circuitry communicably coupled to the collage mode touch processing circuitry, a collage display mode input; and
apportion the image into the respective portions, each of the portions for display on a one of the at least two touchscreen devices, responsive to receipt of the collage display mode input.

25. (canceled)
